(19) United States
(12) Patent Application Publication
(10) Pub. No.: US 2025/0041759 A1
(43) Pub. Date: Feb. 6, 2025

(54) AMBIENT WATER CONDENSER

(71) Applicant: Lonnie G. Johnson, Atlanta, GA (US)

(72) Inventor: Lonnie G. Johnson, Atlanta, GA (US)

(21) Appl. No.: 18/793,186

(22) Filed: Aug. 2, 2024

Related U.S. Application Data
(60) Provisional application No. 63/530,388, filed on Aug. 2, 2023.
(60) Provisional application No. 63/547,632, filed on Nov. 7, 2023.

(51) Int. Cl. B01D 5/00; E03B 3/28

(52) U.S. Cl. CPC B01D 5/006; B01D 5/0033; E03B 3/28; B01D 2257/80; B01D 2313/22

(57) ABSTRACT

An atmospheric water vapor extraction device is contained within reservoir that includes an evaporation chamber, a condensation chamber, a water latent hygroscopic solution within a conduit, a solution container, and a water depleted hygroscopic solution within a conduit. The conduits extend into container to a level below the hygroscopic solution level within the container to prevent passage of air into the conduits. The water extraction device further includes a water collection conduit and water container. The water collection conduit connects the condensation chamber to a water container. The conduit extends into container to a level below the level of water within the container to prevent the passage of air into the conduit and thereby maintain a level of vacuum within chamber that is representative of the weight of the water column within conduit and the vapor pressure of the water at the top.

### CROSS-REFERENCE TO RELATED APPLICATIONS

Applicant claims the benefit of U.S. Provisional Patent Application Ser. No. 63/530,388 filed Aug. 2, 2023 and entitled “Ambient Water Condenser With Vacuum” and U.S. Provisional Patent Application Ser. No. 63/547,632 filed Nov. 7, 2023 and entitled “Ambient Water Condenser.

### FIELD OF THE INVENTION

The present invention relates, in general, to an improved ambient water condenser device, system and method. More specifically, the present invention relates to an improved ambient water condenser apparatuses, assemblies, methods, and systems having components operative in an enclosed environment wherein all components are placed in an enclosed space configured to provide potable water extracted from ambient air.

### BACKGROUND OF THE INVENTION

Although the Earth's surface is approximately seventy-one percent water, over ninety-five percent of this water is found in oceans making it non-potable. The remaining approximately five percent of the Earth's water exists as water vapor, in rivers, in lakes, in icecaps, in glaciers, in ground water, and in aquifers. With the Earth's population exceeding seven billion people, there is an increasing need to provide sources of fresh potable water, especially in arid climates and underdeveloped areas with limited access to water.

Atmospheric water generators utilizing water condensation systems are commonly used to extract water from the ambient atmosphere. However, many of these systems are expensive, requiring bulky inefficient components operating in sizable water condensation systems. The predominant process for extracting water from ambient air is by use of electrical energy driven refrigeration cycles which consume very large amounts of energy. Other solutions include water desalination systems for harvesting water from ocean or sea salt water and fog harvesters that use specialized membranes to collect potable water ambient air. In general, these solutions are quite cumbersome, inefficient, and expensive as well.

Accordingly, there remains a need for improved, efficient, inexpensive atmospheric water extraction systems. There are numerous applications where devices that extract water from the ambient atmosphere would be of useful such as supplying drinking water in geographical locations where fresh water is scarce as well as for maintaining household plants in a watered state. This need and other needs are satisfied by the various aspects of the present disclosure.

### SUMMARY OF THE INVENTION

The present invention uses a hygroscopic solution to condense atmospheric water in combination with a heat driven distillation process to extract the water from the solution. There are numerous applications where an inexpensive device that extracts water from the ambient atmosphere would be useful. Applications range from supplying water for farm irrigation, potable water in geographical locations where fresh water is scarce, to individual buildings where HVAC system electrical load requirements can be reduced by using solar heat to dry air prior to cooling. Heat to drive the process may be provided from a range of sources depending on the application including waste heat such as that released by industrial processes. For large scale production of drinking water in arid climates or supplying dry air to buildings, solar could be an attractive heat source. On the other hand, waste heat from cooking stoves could be used for production of water in smaller scale applications such as watering household flower plants or building dehumidification. The invention provides a significant improvement over past approaches by eliminating the need for permeable membranes as a means for separating potable water from a water solution, particularly hygroscopic and/or saline solutions.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a schematic view of the ambient water condenser embodying principles of the invention in a preferred form.

FIG. 2 is a schematic view of the ambient water condenser embodying principles of the invention in another preferred form.

FIG. 3 is a schematic view of the ambient water condenser embodying principles of the invention in another preferred form.

FIG. 4 is a schematic view of the ambient water condenser embodying principles of the invention in another preferred form.

FIG. 5 is a schematic view of the ambient water condenser embodying principles of the invention in another preferred form.

FIG. 6 is a schematic view of the ambient water condenser embodying principles of the invention in another preferred form.

### DETAILED DESCRIPTION AND PREFERRED EMBODIMENT

### Definitions

For purposes of the present disclosure, it is noted that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly. It should be noted that the reference numbers are not necessarily consistent between the different figures in the drawings.

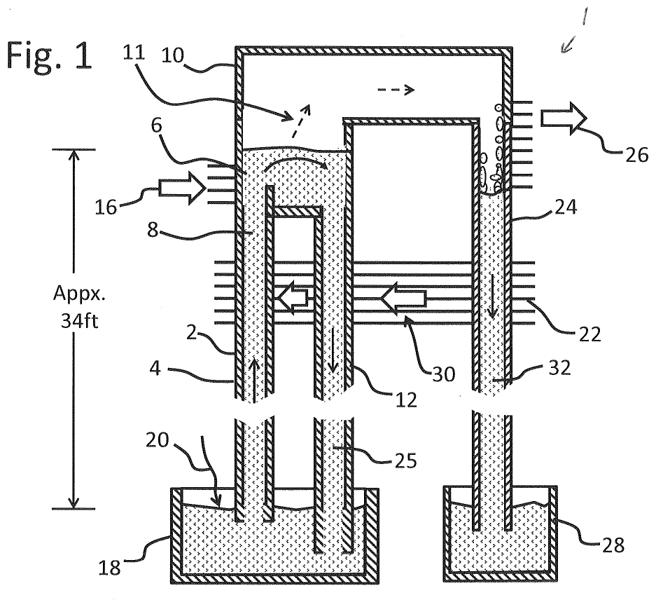

With reference next to the drawings, FIG. 1 shows an atmospheric water vapor extraction device or ambient water condenser 1 that is representative of the present invention. Hygroscopic solution 8 contained within reservoir 2. The ambient water condenser 1 has a reservoir 2 that includes evaporation chamber 6, condensation chamber 10, water latent hygroscopic solution 8 within conduit 4, solution container 18, and water depleted solution 25 within conduit 12. Conduits 4 and 12 extend into solution container 18 to a level below the hygroscopic solution level 20 within the container to prevent passage of air into the conduits 4 and 12. The water extraction device further includes potable water collection conduit 24, and potable water container 28. Water collection conduit 24 connects condensation chamber 10 to water container 28. Conduit 24 extend into water container 28 to a level below the level of water 32 within the container to prevent passage of air into the conduit 24 and thereby maintain a level of vacuum within the condensation chamber 10 that is representative of the weight of the water column within water collection conduit 24 and the vapor pressure of the water at the top. Hygroscopic solution 8 may be a solution of water and Calcium Chloride (CaCl₂:H₂O) or other suitable hygroscopic composition. The salt concentration within the hygroscopic solution will depend on the humidity conditions within the environment from which water is being extracted.

The levels of the column of liquid within reservoir 2 and water collection conduit 24 are greater than approximately 34 feet high depending on the variations in density of the liquids within the columns. At this height, the weights of the liquid columns therein create a vacuum at the top. The vacuum within condensation chamber 10 is in the range of the vapor pressure of the hygroscopic solution 8 and condensed water 32 at the top of the columns. The configuration maintains a level of vacuum within condensation chamber 10 that is representative of the weight of the hygroscopic solution within conduits 4, 12 and 24 versus the vapor pressure of the liquids at the top.

Heat 16 is supplied to hygroscopic solution 8 within evaporation chamber 6. Heat 16 is representative of a generic heat source. The heat 16 may be supplied by an electric heater, solar, fuel combustion or other alternative and coupled to be in thermal communication with the hygroscopic solution 8.

Heat supplied to evaporation chamber 6 causes the water vapor pressure of hygroscopic solution 8 within the evaporation chamber 6 to rise. Water evaporates out of the hygroscopic solution and exits evaporation chamber 6 as illustrated by arrows 11. Steam is evaporated in chamber 6 in a superheated state relative to the temperature of the walls and the pressure within condensation chamber 10. The external walls of the condensation chamber 10 are maintained at a lower temperature relative to the temperature of evaporation chamber 6 by extraction of heat of condensation 26 so that the steam cools and condenses on the inner walls of condensation chamber 10. The condensed water flows out of condensation chamber 10 through water collection conduit 24. It is understood that water solution container 18 may be an ocean or salty sea whereby the water extracted is that which is inherently available in the reservoir.

Continuous operation of the device is driven by the supply of heat to evaporation chamber 6 and removal or extraction of heat of condensation 26 from condensation chamber 10. Evaporation of water from hygroscopic solution 8 within evaporation chamber 6 results in an increase in solution density which causes natural flow under the resulting weight differential. Water vapor 20 is continuously extracted from ambient air with the resulting water rich lower density solution flowing upward through conduit 4 as higher density water depleted hygroscopic solution flows downward through conduit 12 into solution container 18. Water depleted hygroscopic solution 25 enters solution container 18 and absorbs ambient water vapor 20 as the process continues. Recuperative heat exchanger 22 couples or transfers heat between conduits 4, conduit 12, and conduit 24 to improve the thermal operating efficiency of the device by coupling heat 30 from fluid leaving evaporation chamber 6 and condenser chamber 10 to hygroscopic solution flowing to evaporation chamber 6.

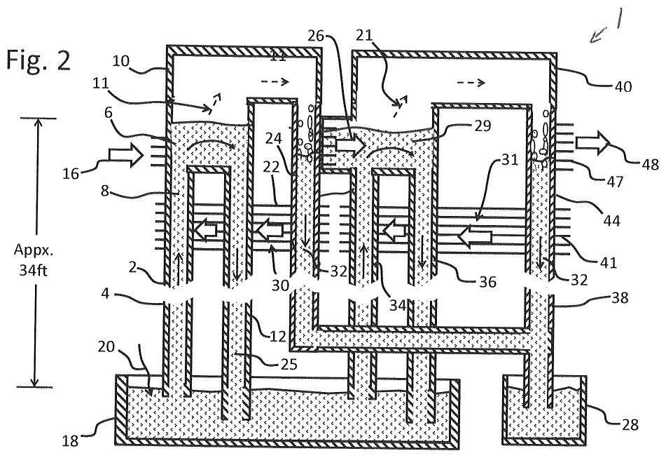

FIG. 2 shows a multistage water extraction device or ambient heat condenser 1 wherein heat of condensation 26 from an initial stage is supplied to evaporation chamber 29 of a subsequent stage for use as heat of evaporation. The subsequent stage operates substantially in a similar manner as the initial stage, although evaporation chamber 29 operates at a somewhat reduced temperature compared to evaporation chamber 6. As water rich hygroscopic solution rises from container 18 through conduit 34 into evaporation chamber 29, heat 26 evaporates water from the hygroscopic solution as illustrated by arrows 21. The resulting dense water depleted hygroscopic solution returns to container 18 through conduit 36 as the resulting water vapor condenses within condensation chamber 40 with heat of condensation 48 being extracted by heat exchanger 47. The condensed potable water is supplied by conduit 38 to collection water container 28

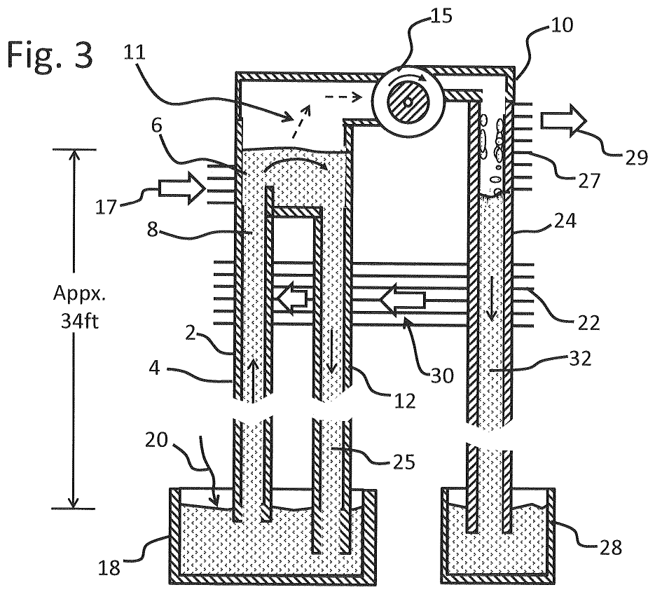

FIG. 3 illustrates the inclusion of pump 15 to extract water vapor 11 from chamber 6 and supply it to condensation chamber 10. The vapor pressure of the hygroscopic solution within chamber 10 is determined by its temperature and the level of hygroscopic solution concentration. Similarly, the vapor pressure of the water within condensation chamber 10 depends on the saturation pressure at its temperature. Under conditions wherein the temperature of hygroscopic solution 8 entering chamber 6 and the condensed water are equal, as would be the case under ideal performance of recuperative heat exchanger 22, the hygroscopic solution will have lower water saturation vapor pressure than the water. Pump 15 operates to overcome the pressure difference and thereby cause condensation of water vapor within condensation chamber 10 at the saturation temperature and pressure of chamber 10. Operation of the pump enables evaporation within chamber 6 at the same temperature as condensation occurs in chamber 10. Operating in this manner, heat source 17 and heat sink 29 can both be at the same temperature, even at ambient temperature. Theoretically, it is not necessary to have distinctly different heat sources and sinks, ambient air could serve as both.

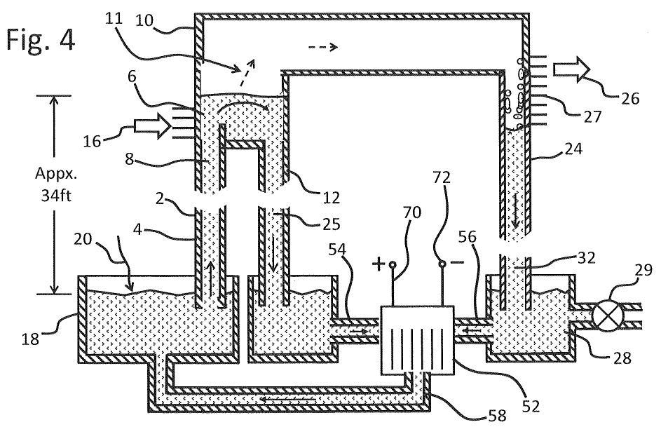

FIG. 4 Illustrates the inclusion of reverse electrodialysis (RED) cell 52 for power generation. The cell is shown with positive electrical terminal 70 and negative terminal 72. Water depleted (concentrated) hygroscopic solution 25 and condensed (substantially pure) water 32 are supplied to the cells via conduits 54 and 56 respectively. The mixed hygroscopic solution that results from the power generation process is supplied to solution container 18 by conduit 58.

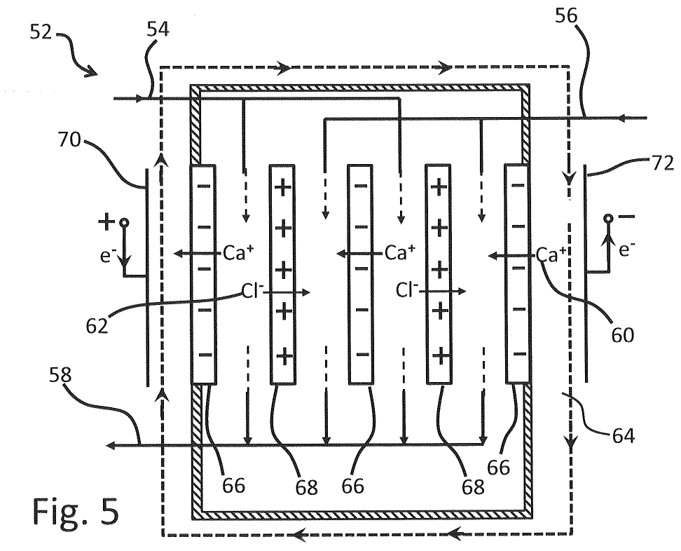

FIG. 5 illustrates operation of representative reverse electrodialysis cell 52. In this example, the hygroscopic solution is aqueous calcium chloride (CaCl:H₂O). Positive ion conductors 66 and negative ion conductors 68 are interleaved to form the electrodialysis stack to achieve a desired voltage. As illustrated, conduit 54 supply concentrated salt solution to the space between electrode pairs sequenced 66->68 whereas conduit 56 supplies substantially pure water to the space between pairs sequenced 68->66. A voltage potential is generated with current under the salt concentration differential as positive calcium ions and negative chlorine ions are conducted through positive ion conductors 66 and negative ion conductors 68 respectively. Electrolyte 64 is circulated between electrodes 70 and 72 to maintain concentration equilibrium between the two electrodes.

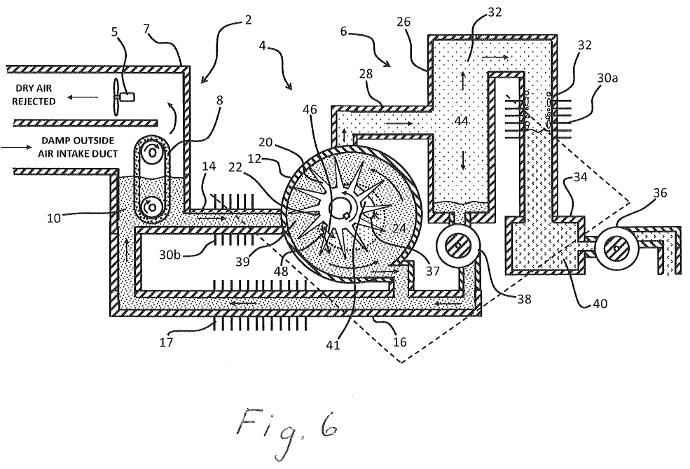

FIG. 6 is a functional diagram of the ambient heat condenser 1 invention. It shows water solution source 2, extraction pump 4, and water condenser 6. Source 2 includes housing 7, blower 5, saline hygroscopic solution 10 and motorized wick belt 8. Blower 5 circulates from the ambient environment through housing 7. Wick 8 circulates in and out of hygroscopic solution 10 to expose the hygroscopic solution to air circulating within housing 7. Hygroscopic solution 10 absorbs humidity from the air. The resulting water latent hygroscopic solution is conducted to extraction pump 4 by conduit 14.

Extraction pump 4 is essentially a modified liquid ring vacuum pump. Pump 4 pulls a vacuum as vaned impeller 20 rotates off center within cylindrical casing 12. Rotating impeller 20 causes hygroscopic solution 10 to form spinning liquid, anulus like, ring 24 within casing 12. As the impeller rotates, gas cavities 39 between blades expand and contract as the blades move in and out of liquid ring 24 held against the inside casing wall of the pump by centrifugal force. Liquid hygroscopic solution enters the pump via conduit 14 and exits via conduit 16 continuously as impeller 20 circulates. Hygroscopic solution 10 enters between blade pairs into expanding cavity at location 22. As the impeller spins causing the cavity to expand, water within hygroscopic solution 10 flash evaporates under the hygroscopic solution's inherent water vapor pressure. The water vapor moves within the void created between impeller blades as indicated by arrow 46 as the denser liquid hygroscopic solution is separated radially outward into the liquid ring under centrifugal force as indicated by arrow 48.

With rotation of the impeller, expansion of the cavities and flash evaporation continue. The cavities reach a maximum at location 37 where they open to exhaust port 41 and where contraction begins. As the impeller continues to rotate, the blades move into the liquid ring causing contraction of the gas cavity between blades. The evaporated water vapor between the blades is forced through exhaust port 41 and on into conduit 28.

Condenser 6 includes mist separation reservoir 44, condensation chamber 32, pump 38, freshwater reservoir 34 and pump 36. Conduit 28 couples the evaporated flow to condenser 6. Given a high spin rate of impeller 20, water will flash evaporate within the gas cavities will generally produce a mixture of water vapor and hygroscopic solution mist. The liquid and vapor separate under centrifugal force as the mixture spins within housing 12. Water vapor generated by pump 4 is supplied to mist separation reservoir 44 by conduit 28. Reservoir 44 further separates water vapor from hygroscopic solution mist and supplies the vapor to condensation chamber 32. Heat exchanger 30a extracts heat of condensation from the water vapor causing it to condense. The condensed fresh water is subsequently supplied to freshwater collection reservoir 40.

Hygroscopic solution 10 absorbs ambient water vapor under ambient air conditions. Therefore, the hygroscopic solution enters pump 4 with a water vapor pressure that is equivalent to the water vapor partial pressure of the ambient air under the prevailing humidity conditions. The hygroscopic solution cavitates between the impellers at the water vapor pressure of the hygroscopic solution. The flash process extracts heat of vaporization from the hygroscopic solution in a high surface area microbubble formation process. The flash process results in a decrease in temperature. The gas is separated from the liquid under centrifugal force as the mixture continues to move within the sousing. The resulting water vapor is compressed as it is pumped through exit port 41 to the pressure of condensation chamber 32. Whereas the hygroscopic solution flashes into a two-phase fluid containing microbubbles resulting in large interface surface area and thereby a rapid rate of heat transfer rate between the two phases. Separation of the two phases under centrifugal force dramatically reduces the magnitude of interface surface area. The water vapor portion is compressed through port 41 without sufficient heat transfer and pressure for recondensation. The separation reservoir is maintained near the flash pressure of water vapor from pump 4 as pump 38 removes small amounts of liquid collected in separation reservoir 44. Pump 36 pumps condensed liquid fresh water from reservoir 40 to ambient pressure as needed.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. An atmospheric water extraction device comprising:
a hydroscopic solution reservoir;
a hygroscopic solution, the hygroscopic solution being contained within the reservoir;
a condensation chamber, and
a heat source, the heat source being coupled to the condensation chamber, the reservoir being configured to have a vertical height between a lower end and an upper end,
the hygroscopic solution within the reservoir being exposed to ambient air at the lower end and coupled to the condensation chamber at the upper end,
the vertical weight of the of the hygroscopic solution within the reservoir creating low pressure within the condensation chamber, and
the heat source supplying heat of evaporation to the hygroscopic solution at the upper end of the reservoir whereby water is evaporated from the hygroscopic solution and condensed within the condensation chamber and collected.

2. The atmospheric water extraction device as disclosed in claim 1 wherein the condensation chamber includes a vertical column of water with a lower end and an upper end,
the water within the column being exposed ambient at the lower end and coupled to the evaporation chamber at the upper end,
the vertical height of the condensed water within the column creating low pressure within the evaporation chamber.

3. The atmospheric water extraction device as disclosed in claim 2 wherein the vertical weight of the of the condensed water within the column creates low pressure substantially near the saturation pressure of the water at the upper end.

4. The atmospheric water extraction and power generation device comprising:
a hydroscopic solution reservoir;
a hygroscopic solution contained within the reservoir;
a condensation chamber, and
a pump coupled to the condensation chamber in between the hydroscopic solution reservoir and the
the reservoir being configured to have a vertical height such that it has a lower end and an upper end,
the hygroscopic solution within the reservoir being exposed ambient at the lower end and coupled to the condensation chamber at the upper end,
the vertical height of the of the hygroscopic solution within the reservoir creating low pressure within the condensation chamber, and
the pump operating to move water vapor from lower vapor pressure of the hygroscopic solution at the upper end of the reservoir to higher pressure whereby water is evaporated from the hygroscopic solution and condensed within the condensation chamber and collected.

5. The atmospheric water extraction device as disclosed in claim 4 wherein the condensation chamber includes a vertical column of water with a lower end and an upper end,
the water within the column being exposed ambient at the lower end and coupled to the evaporation chamber at the upper end,
the vertical height of the condensed water within the column creating low pressure within the evaporation chamber.

6. The atmospheric water extraction device as disclosed in claim 5 wherein the vertical height of the of the condensed water within the column creates low pressure substantially near the saturation pressure of the water at the upper end.

7. The atmospheric water extraction device comprising:
a hydroscopic solution reservoir;
a hygroscopic solution contained within the reservoir;
a condensation chamber;
a heat source coupled to the condensation chamber, and
an electrochemical ion concentration cell,
the reservoir being configured to have a vertical height such that it has a lower end and an upper end,
the hygroscopic solution within the reservoir being exposed ambient at the lower end and coupled to the condensation chamber at the upper end,
the vertical height of the of the hygroscopic solution within the reservoir creating low pressure within the condensation chamber, and
the heat source supplying heat of evaporation to the hygroscopic solution at the upper end of the reservoir whereby water is evaporated from the hygroscopic solution and condensed within the condensation chamber and collected resulting in increased concentration of the hygroscopic solution,
the condensed water and the concentrated hygroscopic solution being supplied to the ion concentration cell whereby the cell generates electrical power from the ion concentration differential.

8. An atmospheric water extraction device as disclosed in claim 5 wherein the condensation chamber includes a vertical column of water with a lower end and an upper end,
the water within the column being exposed ambient at the lower end and coupled to the evaporation chamber at the upper end,
the vertical height of the condensed water within the column creating low pressure within the evaporation chamber.

9. The atmospheric water extraction device as disclosed in claim 8 wherein the vertical height of the of the condensed water within the column creates low pressure substantially near the saturation pressure of the water at the upper end.

10. A water condenser device comprising:
a water solution source;
a water extraction pump, and
a water condenser chamber,
the pump having a water solution input port, a water depleted solution output port and an extracted water output port,
the water condenser chamber being connected to the extracted water output port of the pump and receiving extracted water therefrom,
the water source being connected to the solution input port of the pump and supplying water solution thereto,
the extraction pump flash evaporating water from the water solution by creating low pressure cavitation within the pump and supplying the resulting water vapor through the extracted water output port and supplying water depleted water solution through separate and distinct depleted water solution output port.

11. The water condenser device as disclosed in claim 10 wherein the water solution source is ambient air.

12. The water condenser device as disclosed in claim 10 wherein the water solution source is salt water such as that which may be found in oceans and seas.
